(19) United States
(12) Patent Application Publication
(10) Pub. No.: US 2006/0045123 A1
(43) Pub. Date: Mar. 2, 2006

(54) Method of forming a communication system, a communication card with increased bandwidth, and a method of forming a communication device

(76) Inventor: Sundar Gopalan, San Ramon, CA (US)

Correspondence Address: LAW OFFICES OF MARK C. PICKERING, P.O. BOX 300, PETALUMA, CA, 94953, US

(21) Appl. No.: 10/890,633

(22) Filed: Jul. 14, 2004

(51) Int. Cl. H04J 3/22

(52) U.S. Cl. 370/465; 370/252

(57) ABSTRACT

The data rate of an existing bus interface, such as the universal test and operations interface for ATM (UTOPIA) Level 2 data path interface, is doubled by programming a field programmable gate array that functions as a transceiver to detect data cells on each edge of a clock signal used to transfer data across a bus.

### BACKGROUND OF THE INVENTION

1. Field of the Invention

The present invention relates to communication systems, and more particularly, to a method of forming a communication system, a communication card with increased bandwidth, and a method of forming a communication device.

2. Description of the Related Art

A bus-based communication system is a system that allows a number of communication circuits to exchange signals with each other over a group of shared electrical pathways. For example, the communication circuits on service cards, such as xDSL and other line cards, can be connected to, and communicate over, a bus.

FIG. 1 shows a block diagram that illustrates a prior-art, bus-based communication system 100. As shown in FIG. 1, communication system 100 includes a bus 110, a first card 112 that is electrically connected to bus 110, and a second card 114 that is electrically connected to bus 110.

First card 112 includes a field programmable gate array (FPGA) 120 that is electrically connected to bus 110, and a controller 122 that is electrically connected to FPGA 120. FPGA 120, which provides a physical layer interface to bus 110, receives ATM cells from and transmits ATM cells to bus 110 at a first data rate.

To provide the physical layer interface to bus 110, FPGA 120 is programmed to implement the universal test and operations interface for ATM (UTOPIA) Level 2 data path interface. The UTOPIA Level 2 interface specifies a data rate of 622 Mbps over a 16-bit wide data path at a bus clock speed of either 33 or 50 MHz, where one bit of data can be transferred each bus clock period on each data path. As a result, 16 bits of data can be transferred each bus clock period.

Controller 122, in turn, receives ATM cells from and transmits ATM cells to FPGA 120 at the first data rate. Controller 122, which can receive and forward bursts of ATM cells up to a second data rate that is twice as fast as the first data rate, formats the data to be transmitted to FPGA 120, and processes the data received from FPGA 120.

Second card 114 includes an FPGA 124 that is electrically connected to bus 110, and a controller 126 that is electrically connected to FPGA 124. FPGA 124, which also provides a physical layer interface to bus 110, receives ATM cells from and transmits ATM cells to bus 110 at the first data rate. In addition, FPGA 124 is programmed to implement the UTOPIA Level 2 data path interface.

Further, controller 126 receives ATM cells from and transmits ATM cells to FPGA 124 at the first data rate. Controller 126, which can also receive and forward bursts of ATM cells up to the second data rate, formats the data to be transmitted to FPGA 124, and processes the data received from FPGA 124.

Recent demands for increased bandwidth have led to the development of the UTOPIA Level 3 data path interface. The UTOPIA Level 3 interface specifies a data rate of 2.488 Gbps over a 32-bit wide data path at a bus clock speed of 104 MHz. The UTOPIA Level 3 interface is primarily intended to handle OC-48 traffic.

Although the UTOPIA Level 3 interface provides substantially greater bandwidth, communication system 100 must be redesigned to accommodate the wider data path and the faster bus clock speed. However, the time and expense required to redesign a card to implement the UTOPIA Level 3 interface is significant.

### SUMMARY OF THE INVENTION

The present invention provides a method of forming a communication system, a communication card with increased bandwidth, and a method of forming a communication device. The communication system has a bus, a first device, and a second device. The first device has a first transceiver that is connected to the bus to transmit data to and receive data from the bus at a first data rate. The first device also has a first controller that is connected to the first transceiver to transmit data to and receive data from the first transceiver at the first data rate.

The second device has a second transceiver that is connected to the bus to transmit data to and receive data from the bus at the first data rate. The second device also has a second controller that is connected to the second transceiver to transmit data to and receive data from the second transceiver at the first data rate.

The method of forming the communication system includes the steps of reprogramming the first transceiver to transmit data to and receive data from the bus at a second data rate, and reprogramming the second transceiver to transmit data to and receive data from the bus at the second data rate.

The communication card of the present invention includes a plurality of bus contacts that are connectable to a bus, a transceiver that is programmed to transmit data to and receive data from the bus contacts, and a controller that is electrically connected to the transceiver to transmit data to and receive data from the transceiver. In addition, the communication card meets all the requirements defined by a standard when the transceiver includes a first program, and the card transmits data to and receives data from the bus contacts at a data rate defined by the standard.

In the present invention, the method of forming a communication device includes the steps of identifying a standard that defines a data rate, and forming a card. The card has a plurality of bus contacts that are connectable to a bus, a transceiver that is electrically connected to the bus contacts, and a controller that is electrically connected to the transceiver to transmit data to and receive data from the transceiver.

The card meets all the requirements defined by the standard when the transceiver includes a first program, and the card transmits data to and receives data from the bus contacts at the data rate defined by the standard. In addition, the method includes the step of programming the transceiver to transmit data to and receive data from the bus contacts.

A better understanding of the features and advantages of the present invention will be obtained by reference to the following detailed description and accompanying drawings that set forth an illustrative embodiment in which the principles of the invention are utilized.

### BRIEF DESCRIPTION OF THE DRAWINGS

FIG. 1 is a block diagram illustrating a prior-art, bus-based communications system 100.

FIG. 2 is a flow chart illustrating an example of a method 200 of forming a communication system in accordance with the present invention.

FIG. 3 is a block diagram illustrating a card 300 in accordance with the present invention.

FIG. 4 is a flow chart illustrating an example of a method 400 of forming a communication device in accordance with the present invention.

### DETAILED DESCRIPTION OF THE INVENTION

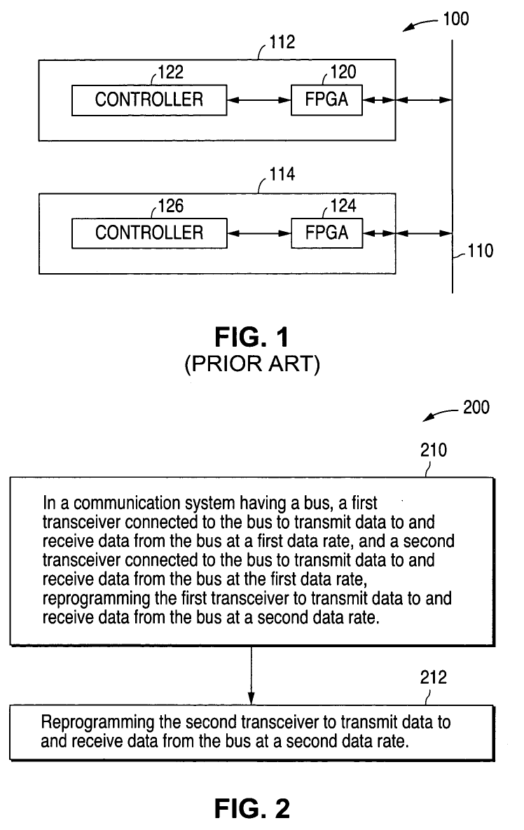

FIG. 2 shows a flow chart that illustrates an example of a method 200 of forming a communication system in accordance with the present invention. The communication system of method 200 includes a bus, such as bus 110 of FIG. 1, a first device, such as card 112 of FIG. 1, and a second device, such as card 114 of FIG. 1.

The first device of method 200 has a first transceiver, such as FPGA 120 of FIG. 1, which is connected to the bus to transmit data to and receive data from the bus at a first data rate that is defined by a standard. In the present invention, a standard is defined to mean a set of requirements, such as the UTOPIA Level 2 data path interface or the UTOPIA Level 3 data path interface, which include a data rate, a bus width, electromagnetic interference (EMI) emission limits, and the like.

In addition, the first device of method 200 also has a first controller, such as controller 122 of FIG. 1, which is connected to the first transceiver to transmit data to and receive data from the first transceiver at the first data rate. Like controller 122, the first controller of method 200 can receive and forward bursts of data up to a second data rate that is twice the first data rate defined by the standard.

The second device of method 200 has a second transceiver, such as FPGA 124 of FIG. 1, which is connected to the bus to transmit data to and receive data from the bus at the first data rate. Further, the second device of method 200 has a second controller, such as controller 126 of FIG. 1, which is connected to the second transceiver to transmit data to and receive data from the second transceiver at the first data rate. As with controller 126, the second controller of method 200 can receive and forward bursts of data up to the second data rate.

Referring again to FIG. 2, method 200 begins at step 210 by reprogramming the first transceiver to transmit data to and receive data from the bus at the second data rate. In addition, the first transceiver is also reprogrammed to transmit data to and receive data from the first controller at the second data rate.

Following this, method 200 moves to step 212 to reprogram the second transceiver to transmit data to and receive data from the bus at the second data rate. Further, the second transceiver is also reprogrammed to transmit data to and receive data from the second controller at the second data rate.

In accordance with the present invention, the first and second transceivers are reprogrammed to transmit and receive data on each edge of a bus clock signal (having a frequency of, for example, 50 MHz) that is used to transfer data across the bus. Thus, unlike the prior art where one bit of data can be transmitted on each data path during each bus clock period, two bits of data can be transmitted on each data path during each bus clock period in method 200 by utilizing each edge of the bus clock signal. As a result, the second data rate is double the first data rate (and can only be double the data rate).

One of the advantages of the present invention is that, since the first and second controllers, such as controllers 122 and 126, are capable of receiving and forwarding bursts of data up to the second data rate, the bandwidth of a bursty UTOPIA Level 2 communications system can be increased from 622 Mbps to 1244 Mbps by only reprogramming the transceivers, such as FPGAs 120 and 124, on the devices, such as cards 112 and 114.

No other changes are necessary. The first controller operates at a clock frequency when receiving data at the first data rate, and operates at the same clock frequency when receiving data at the second data rate. Similarly, the second controller operates at the clock frequency of the first controller when receiving data at the first data rate, and operates at the same clock frequency when receiving data at the second data rate.

Since no other changes are necessary, the devices, such as cards 112 and 114, do not need to be re-qualified to insure that the devices meet all of the requirements, except for the data rate, that are defined by the standard. This is a substantial advantage since the time and cost required to re-qualify a card can be significant.

Thus, although the present invention forms a communication system that has half of the bandwidth of a UTOPIA Level 3 data path interface, the present invention forms a communication system that has twice of the bandwidth of a UTOPIA Level 2 interface for little additional cost.

It is significantly less expensive and requires significantly less time to develop a program for the first and second transceivers to transmit and receive data on each edge of the bus clock signal, and then reprogram the first and second transceivers, than the expense and time required to redesign a device, such as card 112, to have a UTOPIA Level 3 interface.

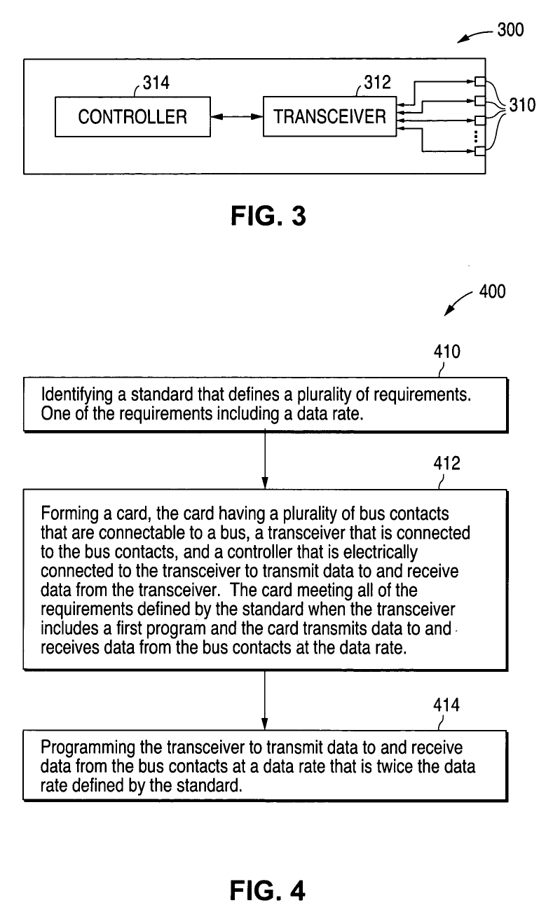

In addition to providing a relatively inexpensive and quick method for doubling the speed of a communications system that utilizes a UTOPIA Level 2 interface, the present invention applies equally to newly-fielded equipment. FIG. 3 shows a block diagram that illustrates a card 300 in accordance with the present invention.

As shown in FIG. 3, card 300 includes a number of bus contacts 310 that are connectable to a bus, and a transceiver 312 that is electrically connected to the bus contacts 310. Transceiver 312, which can be implemented with a field programmable gate array (FPGA), provides a physical layer interface to a bus via the bus contacts 310 to receive data (such as ATM cells) from and transmit data to the bus.

As additionally shown in FIG. 3, card 300 also has a controller 314 that is electrically connected to transceiver 312 to transmit data to and receive data from transceiver 312. Further, controller 314 can receive and forward bursts of data that are twice the data rate specified by a standard.

As noted above, a standard is defined to mean a set of requirements, such as the UTOPIA Level 2 data path interface or the UTOPIA Level 3 data path interface, which include a data rate, a bus width, electromagnetic interference (EMI) emission limits, and the like. In addition, card 300 meets all of the requirements that are defined by the standard when transceiver 312 includes a first program that transmits data to and receives data from the bus contacts 310 at the data rate defined by the standard.

Further, in the present invention, transceiver 312 is programmed to include a second program, which was developed and tested after the first program was developed and tested to insure compliance with the standard, to transmit data to and receive data from the bus at a data rate that is twice the data rate defined by the standard.

The second program also allows transceiver 312 to transmit data to and receive data from controller 314 at the data rate that is twice the data rate defined by the standard. Further, the second program allows transceiver 312 to detect data on each edge of a bus clock signal that is used to transfer data across the bus. In addition, controller 314 operates at a clock frequency when receiving data at the data rate, and operates at the same clock frequency when receiving data at a data rate that is twice the data rate defined by the standard.

Thus, one of the advantages of the present invention is that when used in a bursty environment, such as with xDSL line cards, the present invention allows the date rate of a line card that was originally designed to operate at a data rate defined by a standard to be doubled by only programming the transceiver 312 with the subsequently developed second program.

Another advantage of the present invention is that the increased performance comes at no additional production cost. As a result, the bandwidth of a bursty UTOPIA Level 2 communication card can be increased from 622 Mbps to 1244 Mbps by only programming the transceivers with the second program. Thus, the present invention provides a substantial increase in performance at little additional cost.

As above, a further advantage of the present invention is that card 300 does not need to be re-qualified to insure that it meets all of the requirements, except for the data rate, that are defined by the standard, such as the UTOPIA Level 2 data path interface or the UTOPIA Level 3 data path interface.

FIG. 4 shows a flow chart that illustrates an example of a method 400 of forming a communication device in accordance with the present invention. As shown in FIG. 4, method 400 begins at step 410 by identifying a standard. As above, a standard is defined to mean a set of requirements, such as the UTOPIA Level 2 data path interface or the UTOPIA Level 3 data path interface, which include a data rate, a bus width, electromagnetic interference (EMI) emission limits, and the like.

Once a standard has been identified, method 400 moves to step 412 to form a line card, such as an xDSL line card. The card, which can be implemented with card 300, has a number of bus contacts, such as contacts 310, and a transceiver, such as transceiver 312, that is electrically connected to the bus contacts.

In addition, the card has a controller, such as controller 314, that is electrically connected to the transceiver to transmit data to and receive data from the transceiver. Further, the card of method 400 meets all of the requirements defined by the standard when the transceiver includes a first program, and the transceiver transmits data to and receives data from the bus contacts at the data rate defined by the standard.

After the card has been formed, method 400 moves to step 414 to program the transceiver with a second program, which was developed and tested after the first program was developed and tested to insure compliance with the standard, to transmit data to and receive data from the bus at a data rate that is twice the data rate defined by the standard. Alternately, the transceiver of method 400 can be programmed before the card is formed.

In addition, the second program also allows the transceiver to transmit data to and receive data from the controller at a data rate that is twice the data rate defined by the standard. Further, the second program allows the transceiver to detect data on each edge of a bus clock signal that is used to transfer data across the bus.

As a result, the present invention can be utilized with newly-fielded equipment by programming the transceiver with the second program to transmit data to and receive data from the bus at the data rate which is twice the data rate defined by the standard, such as the UTOPIA Level 2 data path interface or the UTOPIA Level 3 data path interface.

Thus, when the transceiver is programmed for newly-fielded equipment, the transceiver can be initially programmed to transmit data to and receive data from the transceiver at twice the speed defined by the standard. As with method 200, the controller of method 400. operates at a clock frequency when receiving data at the data rate defined by the standard, and operates at the same clock frequency when receiving data at the data rate which is twice the data rate defined by the standard.

It should be understood that the above descriptions are examples of the present invention, and that various alternatives of the invention described herein may be employed in practicing the invention. Thus, it is intended that the following claims define the scope of the invention and that structures and methods within the scope of these claims and their equivalents be covered thereby.

What is claimed is:

1. A method of forming a communication system, the communication system having:
a bus;
a first device having:
a first transceiver connected to the bus that transmits data to and receives data from the bus at a first data rate; and
a first controller connected to the first transceiver that transmits data to and receives data from the first transceiver at the first data rate; and
a second device having:
a second transceiver connected to the bus that transmits data to and receives data from the bus at the first data rate; and
a second controller connected to the second transceiver that transmits data to and receives data from the second transceiver at the first data rate;
the method comprising the steps of:
reprogramming the first transceiver to transmit data to and receive data from the bus at a second data rate; and
reprogramming the second transceiver to transmit data to and receive data from the bus at the second data rate.

2. The method of claim 1 wherein the second data rate is double the first data rate.

3. The method of claim 2 wherein the first controller operates at a clock frequency when receiving data at the first data rate, and operates at the clock frequency when receiving data at the second data rate.

4. The method of claim 3 wherein the second controller operates at the clock frequency when receiving data at the first data rate, and operates at the clock frequency when receiving data at the second data rate.

5. The method of claim 3 wherein the first transceiver and the second transceiver are field programmable gate arrays.

6. The method of claim 5 wherein the first and second devices are line cards.

7. The method of claim 6 wherein the first controller receives data in bursts.

8. A card comprising:
a plurality of bus contacts that are connectable to a bus;
a transceiver that is programmed to transmit data to and receive data from the bus contacts; and
a controller that is electrically connected to the transceiver to transmit data to and receive data from the transceiver,
the card meeting all requirements defined by a standard when the transceiver includes a first program and the card transmits data to and receives data from the bus contacts at a data rate defined by the standard.

9. The card of claim 8 wherein the transceiver is programmed to include a second program to transmit data to and receive data from the bus at a data rate that is twice the data rate defined by the standard.

10. The card of claim 9 wherein the standard is UTPOIA Level 2.

11. The card of claim 9 wherein the standard is UTPOIA Level 3.

12. The card of claim 9 wherein data is detected on each edge of a bus clock signal used to transfer data across the bus.

13. The card of claim 12 wherein the controller can only receive bursts of data at the data rate that is twice the data rate defined by the standard.

14. A method of forming a communication device, the method comprising the steps of:
identifying a standard that defines a data rate;
forming a card, the card having:
a plurality of bus contacts that are connectable to a bus;
a transceiver that is connected to the bus contacts; and
a controller that is electrically connected to the transceiver to transmit data to and receive data from the transceiver,
the card meeting all requirements defined by the standard when the transceiver includes a first program and the card transmits data to and receives data from the bus contacts at the data rate defined by the standard; and
programming the transceiver to transmit data to and receive data from the bus contacts.

15. The method of claim 14 wherein the transceiver is programmed to include a second program that transmits data to and receives data from the bus contacts at a data rate that is twice the data rate defined by the standard.

16. The method of claim 15 wherein the controller operates at a clock frequency when receiving data at the data rate defined by the standard, and operates at the clock frequency when receiving data at the data rate that is twice the data rate defined by the standard.

17. The method of claim 15 wherein the standard is UTPOIA Level 2.

18. The method of claim 15 wherein the standard is UTPOIA Level 3.

19. The method of claim 15 wherein data is detected on each edge of a bus clock signal used to transfer data across the bus.

20. The method of claim 15 wherein the second program was developed after the first program.
